(19) United States
(12) Patent Application Publication
(10) Pub. No.: US 2010/0105349 A1
(43) Pub. Date: Apr. 29, 2010

(54) Rf signal sampling apparatus and method

(76) Inventor: Xuecheng Qian, Shanghai (CN)

Correspondence Address: Docket Clerk, P.O. Box 802432, Dallas, TX, 75380, US

(21) Appl. No.: 12/309,253

(22) PCT Filed: Jul. 9, 2007
(86) PCT No.: PCT/IB2007/052695

§ 371 Date: Sep. 21, 2009

(30) Foreign Application Priority Data
Jul. 11, 2006 (CN) 200610101935.4

(51) Int. Cl. H04B 1/26

(52) U.S. Cl. 455/323

(57) ABSTRACT

The invention relates to an RF signal sampling apparatus for a wireless receiver, comprising a first transconductor circuit (Gmi), for converting received RF voltage signals into current signals, a first HR filter, for down-sampling and filtering the current signals, and an FIR filter, for further filtering, down-sampling and outputting the signals which are outputted by the first HR filter.

### FIELD OF THE INVENTION

The invention relates generally to a wireless communication technology, and more particularly, to a radio frequency (RF) signal sampling apparatus and method for a wireless receiver.

### BACKGROUND OF THE INVENTION

A conventional wireless receiver down-converts and fully filters the received RF signals in analog (continuous-time) domain. To reduce the cost of the receiver, the analog circuits and the digital signal processing (DSP) circuits usually should share the same semiconductor chip. Presently, the receiver architecture using RF sampling is highly desirable due to the fact that it is easy to reconfigure and integrate the analog and digital circuits on silicon chips of the same process. FIG. 1 is a block diagram showing usual architecture of an RF sampling receiver. The receiver comprises an antenna, an RF filter RFF, a low noise amplifier LNA, a switch under the control of a clock signal Clk, a discrete-time filter DF, an analog-to-digital converter ADC and a subsequent DSP circuit. After RF filtering and amplification, the analog RF signals received at the antenna are sampled directly. Generally, the signals received at the antenna comprise the desired signals, and broadband interference signals as well. Furthermore, the RF filter has a limited suppression over the out-of-band (OOB) interference. To prevent interference aliasing from entering into the frequency band of the desired signals during sampling, the required sampling rate must be very high.

However, because the RF receiver requires a high sampling frequency, its power consumption is usually high. Typically, more circuits operating at high frequency (HF) will result in higher power consumption for the receiver. This is the main reason why conventional RF sampling receivers have not been applied widely so far.

In “A 3-V 230-MHz CMOS Decimation Subsampler” by Saska Lindfors, Aarno Parssinen and Kari A. I. Halonen, IEEE Trans. on Circuits and Systems-II: Analog and Digital Signal Processing, Vol. 50, No. 3, March 2003, a finite impulse response (FIR) down-sampling filter is proposed to decrease the sampling frequency of a voltage sample receiver. However, the circuitry is very complex in comparison with conventional samplers.

Charge sampling techniques are described in “A Charge Sampling Mixer with Embedded Filter Function for Wireless Applications” by Jiren Yuan, IEEE 2000 2^{nd} International Microwave and Millimeter Wave Conference, WO 01/24192 “Versatile charge sampling circuits” and “A discrete-time Bluetooth receiver in a 0.13/spl mu/m digital CMOS process” by Muhammad K. Leipold, IEEE International Solid-State Circuits Conference (ISSCC), Vol. 1, pp 268-527, 15^{th}-19^{th} Feb., 2004. In a charge-sampling receiver, analog voltage input signals are first converted into current signals, and then a capacitor is charged with the current signals in a certain period. An equivalent down-sampling FIR filter is formed by integrating the charges accumulated in several consecutive periods, and thus signals are output at a lower sampling rate.

However, the spectral notch formed by the FIR filter is not wide enough, and so the down-sampling factor cannot be too large. Muhammad K. Leipold et al suggest suppressing the OOB interference with analog infinite impulse response (IIR) and FIR filters before further down-sampling the signals. However, there is a need for a very complex circuit and plenty of clock signals, which will increase the cost and power consumption for the circuit.

### SUMMARY OF THE INVENTION

It is an object of the invention to provide an RF signal sampling apparatus and method with low lost and low complexity for a wireless receiver. The invention is defined by the independent claims. Dependent claims describe advantageous embodiments.

According to the invention, an RF signal sampling apparatus for a wireless receiver comprises:

a first transconductor unit (Gm₁), for converting the received RF voltage signals into current signals;

a first IIR filter, for down-sampling and filtering the current signals; and an FIR filter, for further filtering, down-sampling and outputting the signals output from the first IIR filter.

According to the invention, an RF signal sampling method for a wireless receiver comprises:

converting the received RF voltage signals into current signals;

sampling and first IIR filtering the current signals; and

FIR filtering and down-sampling the IIR filtered signals, to obtain further down-sampled output signals.

Compared with prior art documents, the RF signal sampling apparatus and method of the invention may implement high frequency selectivity by using simple discrete filters. The overall circuit structure is simpleer, requiring fewer clock signals, and thus reducing the complexity and power consumption.

### BRIEF DESCRIPTION OF THE DRAWINGS

The above and other advantages will be apparent from the exemplary description of the accompanying drawings in which

FIG. 1 is a block diagram showing an exemplary architecture of an RF sampling receiver according to prior art;

FIG. 2A and FIG. 2B illustrate a block diagram of an RF receiver comprising an RF sampling receiver according to an embodiment of the invention and the timing diagram for the clock signals therein, respectively;

FIG. 3 is a diagram showing the normalized amplitude response for the IIR filter in the RF sampling apparatus of FIG. 2;

FIG. 4 is a diagram showing the normalized amplitude response for the IIR filter in the RF sampling apparatus of FIG. 2 with respect to different capacitance ratios;

FIG. 5 is a diagram showing the normalized amplitude response for the FIR filter in the RF sampling apparatus of FIG. 2; and

FIG. 6A and FIG. 6B illustrate a block diagram of an RF receiver comprising an RF sampling receiver according to another embodiment of the invention and the timing diagram for the clock signals therein, respectively.

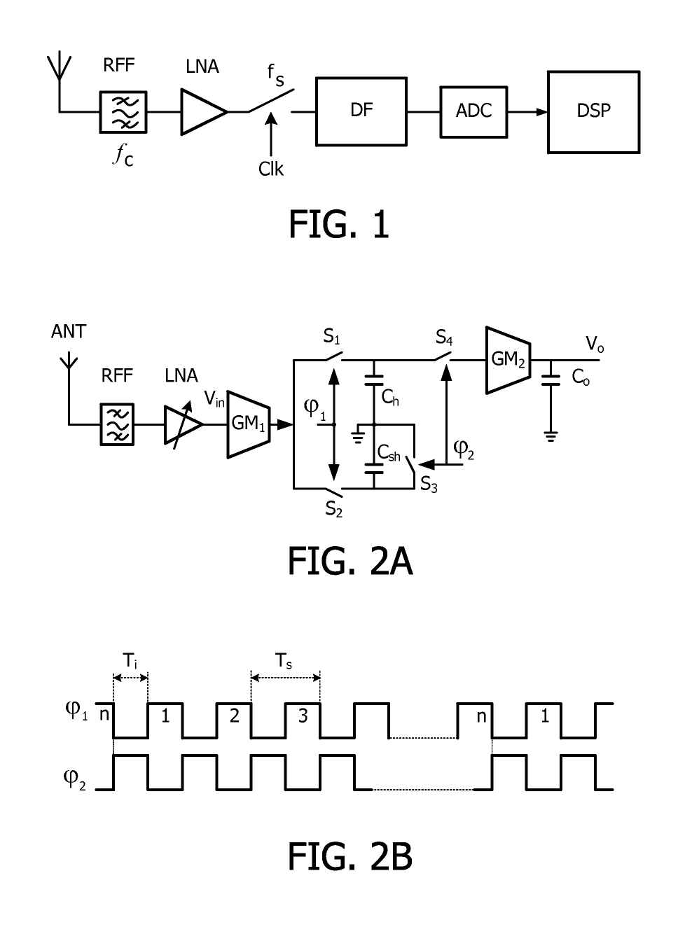

In the drawings same reference numbers refer to same, similar or corresponding features or functions.

### DETAILED DESCRIPTION OF THE INVENTION

FIG. 2A shows a block diagram of an RF receiver comprising an RF sampling receiver according to an embodiment of the invention. The RF receiver comprises an antenna ANT, an RF filter RFF, a low noise amplifier LNA, a first transconductor unit Gm₁, a first switch S₁ and a second switch S₂ under the control of a first clock signal φ₁, a holding capacitor Cₕ, a sharing capacitor Cₛₕ, a third switch S₃ and a fourth switch S₄ under the control of a second clock signal φ₂, a second transconductor unit Gm₂, and an outputting capacitor Cₒ.

The holding capacitor Cₕ and the sharing capacitor Cₛ, are coupled in parallel respectively by the first and second switches S₁ and S₂, and then coupled to the first transconductor unit Gm₁ in series. The fourth switch S₄ is connected between the holding capacitor Cₕ and the second transconductor unit Gm₂. The third switch S₃ is coupled with the sharing capacitor Cₛₕ in parallel. The output of the second transconductor unit Gm₂ is coupled to the outputting capacitor Cₒ.

FIG. 2B shows the timing relationship between the first and second clock signals φ₁ and φ₂. The period Tₛ corresponds to a clock cycle for the first and second clock signals φ₁ and φ₂, and the period Tᵢ corresponds to the duration of low level in a cycle of the first clock signal φ₁ and the duration of high level in a cycle of second clock signal φ₂.

It can be concluded from FIG. 2A and FIG. 2B that the input signals from the antenna ANT are first processed by the RF filter RFF and the low noise amplifier LNA, and then the analog voltage signals Vᵢₙ, are output to the first transconductor unit Gm₁. Next, the first transconductor unit Gm₁ converts the input voltage signals Vᵢₙ into current signals. The current signals are accumulated on the holding capacitor Cₕ and the sharing capacitor Cₛ, periodically at a frequency of fₛ, that is, when the first clock signal φ₁ is on the high level, the first and second switches S₁ and S₂ are closed during the period Tᵢ to charge the holding capacitor Cₕ and the sharing capacitor Cₛₕ. Here, the frequency fₛ corresponds to the sampling frequency, which should be high enough to prevent interference aliasing from entering into the desired frequency band.

Before the next charging period, the second clock signal φ₂ is on the high level (while the first clock signal φ₁ is on the low level), and the third switch S₃ is closed to discharge the sharing capacitor Cₛₕ, so as to reset its voltage to zero. At the same time, the fourth switch S₄ is closed, so that the voltage on the holding capacitor Cₕ is converted into current signals by the second transconductor unit Gm₂ and accumulated on the outputting capacitor Cₒ.

When the first clock signal φ₁ is on the high level, the periodical charge sharing between the holding capacitor Cₕ and the sharing capacitor Cₛₕ forms a 1^{st} order IIR filter with an operating frequency of fₛ. The response of the IIR filter corresponds to:

$$H ( j w ) = \frac{{U}_{n} ( z )}{{Q}_{n} ( z )} = \frac{α}{1 - β {Z}^{- 1}} = \frac{α Z}{Z - β} {\vert}_{Z = {e}^{jwT}} \\ where α = \frac{1}{{C}_{h} + {C}_{sh}} and β = \frac{{C}_{h}}{{C}_{h} + {C}_{sh}} .$$

The normalized frequency response is dependent on β to a large extent and hence on the ratio,

$$\frac{{C}_{h}}{{C}_{sh}}$$

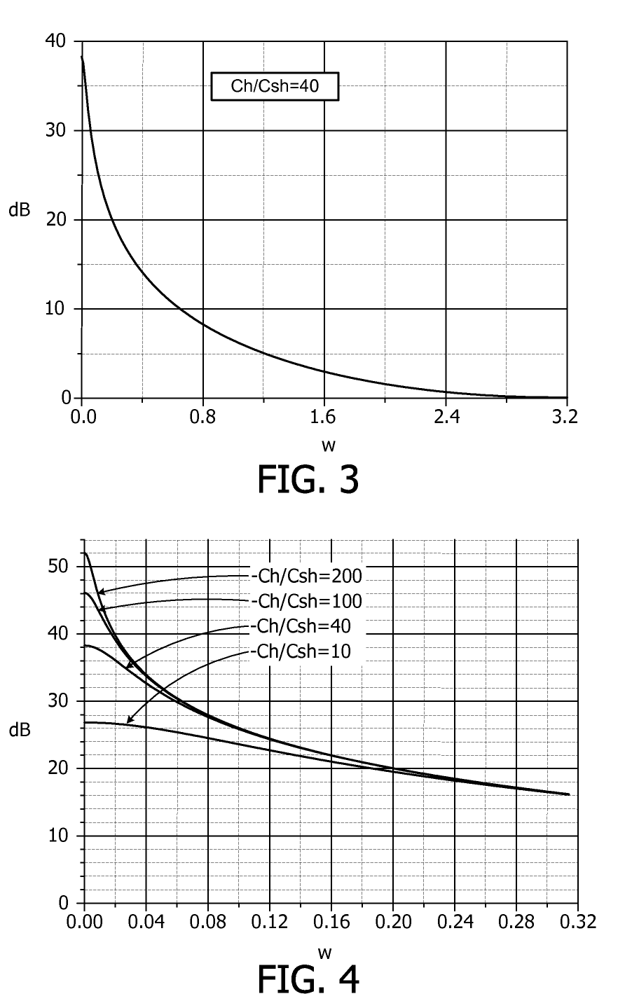

too. For example, when the ratio is 40, the normalized amplitude response of the IIR filter is illustrated in FIG. 3. FIG. 4 is a diagram showing the normalized amplitude response for the IIR filter with respect to different capacitance ratios, where examples of normalized responses for the capacitance ratios 10, 40, 100 and 200 are depicted, respectively. It can be seen that a higher

$$\frac{{C}_{h}}{{C}_{sh}}$$

will lead to a higher DC (zero frequency) gain.

By charging the outputting capacitor Cₒ in n consecutive cycles, an FIR filter having n taps is formed. The response of the FIR filter is:

$$H ( j w ) = \frac{sin ( \frac{{nwT}_{s}}{2} )}{sin ( \frac{{wT}_{s}}{2} )} {e}^{\frac{- j ( n - 1 ) {wT}_{s}}{2}}$$

$$where {T}_{s} = \frac{1}{{f}_{s}} .$$

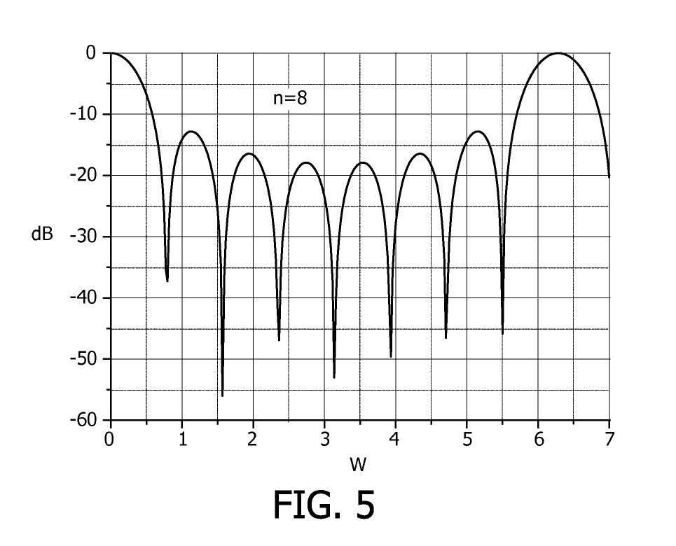

FIG. 5 is a diagram showing the normalized amplitude response for the FIR filter. Here, as a functional example of the FIR filter, n is equal to 8. On the basis of the notch in the spectrum of the FIR filter and the selectivity of the foregoing IIR filter, it may be ensured that no strong interference aliasing will enter into the desired signal band during down-sampling as long as n is not very large. In this way, the voltage signals on the outputting capacitor Cₒ may be down-converted to the frequency of fₛ/n.

The 1^{st} order IIR filter (comprising the capacitor Cₕ, the first switch S₁, the second switch S₂, the third switch S₃, the holding capacitor Cₕ and the sharing capacitor Cₛₕ) and the FIR down-sampling filter (the fourth switch S₄, the second transconductor unit Gm₂ and the outputting capacitor Cₒ) construct an RF signal sampling apparatus according to an embodiment of the invention.

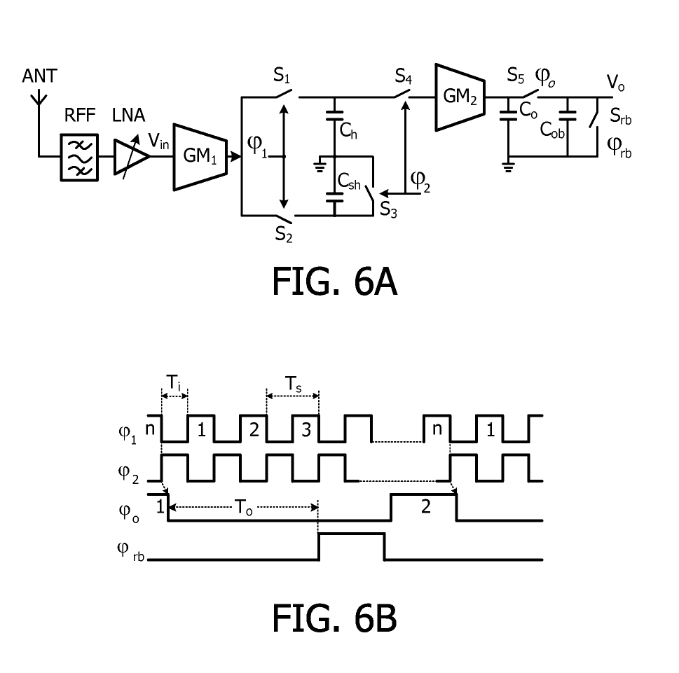

FIG. 6A shows a block diagram of an RF receiver comprising an RF sampling receiver according to another embodiment of the invention. The RF receiver also comprises an antenna ANT, an RF filter RFF, a low noise amplifier LNA, a first transconductor unit Gm₁, a first switch S₁ and a second switch S₂ under the control of a first clock signal φ₁, a holding capacitor Cₕ, a sharing capacitor Cₛₕ, a third switch S₃ and a fourth switch S₄ under the control of a second clock signal φ₂, a second transconductor unit Gm₂, and an outputting capacitor Cₒ. The RF receiver further comprises a buffering capacitor C_{ob}, a resetting switch S_{rb} under the control of a resetting clock signal φ_{rb} and a fifth switch S₅ under the control of an outputting clock signal 90.

The holding capacitor Cₕ and the sharing capacitor Cₛₕ are coupled in parallel respectively by the first and second switches S₁ and S₂, and then coupled to the first transconductor unit Gm₁ in series. The fourth switch S₄ is connected between the holding capacitor Cₕ and the second transconductor unit Gm₂. The third switch S₃ is coupled with the sharing capacitor Cₛₕ in parallel. The output of the second transconductor unit Gm₂ is coupled to the outputting capacitor Cₒ. The buffering capacitor C_{ob} and the fifth switch S₅ are serially connected and then connected with the outputting capacitor Cₒ in parallel. The resetting switch S_{rb} is connected with the buffering capacitor C_{ob} in parallel.

FIG. 6B shows the timing relationship between the first and second clock signals φ₁ and φ₂, the outputting clock signal φₒ and the resetting clock signal φ_{rb}. The period Tₛ corresponds to a clock cycle for the first and second clock signals φ₁ and φ₂, and the period Tᵢ corresponds to the duration of low level in a cycle of the first clock signal φ₁ and the duration of high level in a cycle of second clock signal φ₂. The output period Tₒ is a time period between a falling edge of the outputting clock signal φₒ and a rising edge of the subsequent resetting clock signal φ_{rb}.

Similar to the first embodiment, it can be concluded from FIG. 6A and FIG. 6B that the input signals from the antenna ANT are first processed by the RF filter RFF and the low noise amplifier LNA, and then analog voltage signals Vᵢₙ are output to the first transconductor unit Gm₁. Next, the first transconductor unit Gm₁ converts the input voltage signals Vᵢₙ into current signals. The current signals are accumulated onto the holding capacitor C_{b} and the sharing capacitor C_{A} periodically at a frequency fₛ, that is, when the first clock signal φ₁ is on the high level, the first and second switches S₁ and S₂ are closed during the period Tᵢ to charge the holding capacitor Cₕ and the sharing capacitor Cₛₕ. Here, the frequency fₛ corresponds to the sampling frequency, which should be high enough to prevent interference aliasing from entering into the desired frequency band.

Before the next charging period, the second clock signal φ₂ is on the high level (while the first clock signal φ₁ is on the low level), and the third switch S₃ is closed to discharge the sharing capacitor Cₛₕ, so as to reset its voltage to zero. At the same time, the fourth switch S₄ is also closed, so that the voltage on the holding capacitor Cₕ is converted into current signals by the second transconductor unit Gm₂ and accumulated on the outputting capacitor Cₒ.

When the outputting clock signal φₒ is on the high level, the fifth switch S₅ is closed, and the buffering capacitor C_{ob} shares the charges on the outputting capacitor Cₒ. When the outputting clock signal φₒ is on the high level, the voltage signals on the buffering capacitor C_{ob} are output signals with a frequency of fₛ/n. Before the next charge sharing between the buffering capacitor C_{ob} and the outputting capacitor Cₒ, when the resetting clock signal φ_{rb} is on the high level, the resetting switch S_{rb} is closed to discharge the buffering capacitor C_{ob} so as to reset its voltage to zero.

The periodical charge sharing between the holding capacitor Cₕ and the sharing capacitor Cₛₕ forms a 1^{st} order IIR filter with an operating frequency of fₛ. The response of the IIR filter corresponds to:

$$H ( j w ) = \frac{{U}_{n} ( z )}{{Q}_{n} ( z )} = \frac{α}{1 - β {Z}^{- 1}} = \frac{α Z}{Z - β} {\vert}_{Z = {e}^{jwT}} , \\ where α = \frac{1}{{C}_{h} + {C}_{sh}} and β = \frac{{C}_{h}}{{C}_{h} + {C}_{sh}} .$$

By charging the outputting capacitor Cₒ in n consecutive cycles, an FIR filter having n taps is formed. The response of the FIR filter is:

$$H ( j w ) = \frac{sin ( \frac{{nwT}_{s}}{2} )}{sin ( \frac{{wT}_{s}}{2} )} {e}^{\frac{- j ( n - 1 ) {wT}_{s}}{2}} , \\ where {T}_{s} = \frac{1}{{f}_{s}} .$$

Additionally in the present embodiment, the charge sharing between the buffering capacitor C_{ob} and the outputting capacitor Cₒ forms another 1^{st} order IIR filter operating at the frequency of fₛ/n, which provides additional selectivity for the OOB interference. The response of the IIR filter corresponds to:

$$H ( j w ) = \frac{{V}_{n} ( z )}{{Q}_{n} ( z )} = \frac{p}{1 - q {Z}^{- 1}} = \frac{p Z}{Z - q} {\vert}_{Z = {e}^{jwT}} , \\ where p = \frac{1}{{C}_{o} + {C}_{b}} and q = \frac{{C}_{o}}{{C}_{o} + {C}_{b}} .$$

The normalized frequency response is dependent on q to a large extent and thus on the ratio

$$\frac{{C}_{o}}{{C}_{b}}$$

too. A higher

$$\frac{{C}_{o}}{{C}_{b}}$$

will lead to a higher DC (zero frequency) gain.

Compared with prior arts, the RF signal sampling apparatus of the invention may implement high frequency selectivity by using simple discrete filters. First, the charge sampling technology is used to suppress the OOB interference and simplify the implementation of the IIR down-sampling filter. Second, a 1^{st} order FIR filter, which is very simple, is used to reduce noises before further down-sampling. Finally, a simple down-sampling architecture is used to decrease the sampling frequency. The whole circuit only needs to add very few capacitors, switches and a necessary down-sampling circuit. In addition, very few clock signals are needed. Thus, the complexity and power consumption are reduced.

Alternatively, the RF signal sampling apparatus and method disclosed in the invention may be applied to various RF sampling receivers in wireless communications.

It is to be understood by those skilled in the art that the specific embodiments in the invention are intended to be illustrative rather than limiting. Various improvements and modifications may be made to the RF signal sampling apparatus and method disclosed in the invention without departing from the basis of the invention, the scope of which is to be defined by the attached claims herein.

It is remarked that the scope of protection of the invention is not restricted to the embodiments described herein. Neither is the scope of protection of the invention restricted by the reference numerals in the claims. The word “comprising” does not exclude other parts than those mentioned in the claims. The word “a(n)” preceding an element does not exclude a plurality of those elements. Means forming part of the invention may both be implemented in the form of dedicated hardware or in the form of a programmed purpose processor. The invention resides in each new feature or combination of features.

1. A radio frequency (RF) signal sampling apparatus for a wireless receiver, comprising:
a first transconductor circuit (Gm₁), for converting received RF voltage signals into current signals;
a first infinite impulse response (IIR) filter, for down-sampling and filtering the current signals; and
finite impulse response (FIR) filter, for further filtering, down-sampling and outputting the signals which are outputted by the first IIR filter.

2. The RF signal sampling apparatus according to claim 1, further comprising:
a second IIR filter, for filtering again the signals outputted by the first IIR filter, to further decrease the sampling frequency.

3. The RF signal sampling apparatus according to claim 2, wherein, the first IIR filter comprises:
a first capacitor (Cₕ), to be charged with the current signals;
a first switch (S₁) under the control of a first clock signal (φ₁), for passing periodically the current signals to the first capacitor;
a second capacitor (Cₛₕ), to be charged with the current signals;
a second switch (S₂) under the control of the first clock signal (φ₁), for passing periodically the current signals to the second capacitor; and
a third switch (S₃) under the control of a second clock signal (φ₂), for resetting the voltage on the second capacitor (Cₛₕ).

4. The RF signal sampling apparatus according to claim 3, wherein the FIR filter comprises:
a fourth switch (S₄) under the control of the second clock signal (φ₂), for drawing periodically the voltage signals on the first capacitor (Cₕ);
a second transconductor circuit (Gm₂), for converting the voltage signals on the first capacitor (Cₕ) into current signals; and
a third capacitor (Cₒ), to be charged with the current signals output from the second transconductor circuit (Gm₂).

5. The RF signal sampling apparatus according to claim 4, wherein the second IIR filter comprises:
the third capacitor (Cₒ;
a fourth capacitor (C_{ob}), for sharing the charges on the third capacitor;
a fifth switch (S₅) under the control of an output clock signal (φₒ), for coupling the third capacitor to the fourth capacitor; and
a resetting switch (S_{rb}) under the control of a resetting clock signal (φ_{ob}), for resetting the voltage on the fourth capacitor.

6. A radio frequency (RF) signal sampling method for a wireless receiver, the method comprising:
converting the received RF voltage signals into current signals;
sampling and first infinite impulse response (IIR) filtering the current signals; and
finite impulse response (FIR) filtering and down-sampling the IIR filtered signals, to obtain further down-sampled output signals.

7. The RF signal sampling method according to claim 6, further comprising:
second IIR filtering the IIR filtered output signals, to further decrease the sampling frequency.

8. A wireless receiver, comprising:
an radio frequency filter (RFF), for receiving and filtering radio frequency (RF) signals;
a low noise amplifier (LNA), for amplifying the filtered RF signals; and
a radio frequency (RF) signal sampler, comprising:
a first transconductor circuit (Gm₁), for converting the amplified RF voltage signals into current signals;
a first infinite impulse response (IIR) filter, for down-sampling and filtering the current signals; and
an FIR filter, for further filtering, down-sampling and outputting the signals output from the first IIR filter.

9. The RF signal sampling apparatus according to claim 8, further comprising:
a second IIR filter, for filtering again the signals output from the first IIR filter, to further decrease the sampling frequency.
